(19) United States
(12) Patent Application Publication
(10) Pub. No.: US 2025/0074425 A1
(43) Pub. Date: Mar. 6, 2025

(54) DRIVING ASSISTANCE SYSTEM, VEHICLE, AND COMPUTER-READABLE RECORDING MEDIUM

(71) Applicant: HL KLEMOVE CORP., Incheon (KR)

(72) Inventor: Taehan KIM, Gyeonggi-do (KR)

(21) Appl. No.: 18/798,830

(22) Filed: Aug. 9, 2024

(30) Foreign Application Priority Data
Aug. 28, 2023 (KR) 10-2023-0113148

(51) Int. Cl. B60W 30/18; G06V 20/56

(52) U.S. Cl. CPC B60W 30/18163; B60W 2420/403; B60W 2552/10; B60W 2554/406; G06V 20/588

(57) ABSTRACT

A driving assistance system includes a camera module provided in or associated with a vehicle and configured to capture a surrounding image and a controller configured to control driving of the vehicle based on camera information provided from the camera module and navigation information provided from a navigation module or associated with the vehicle, and the controller is configured to compare a distance to a diverging point of a road on which the vehicle is traveling with a reference distance, set a lane closest to the diverging point as a target lane when the distance to the diverging point is less than the reference distance, and control the vehicle to move to the target lane.

### CROSS-REFERENCE TO RELATED APPLICATION

This application claims the benefit of and priority to Korean Patent Application No. 10-2023-0113148, filed on Aug. 28, 2023 in the Korean Intellectual Property Office, the disclosure of which is incorporated herein by reference herein in its entirety.

### BACKGROUND

### 1. Field

Some embodiments of the present disclosure generally relate to a driving assistance system capable of automatically driving a vehicle using navigation information and camera information, a vehicle including the same, and a computer-readable recording medium.

### 2. Description of the Related Art

In recent years, research on autonomous vehicles capable of traveling on their own has been actively conducted. The autonomous vehicle may be a vehicle that uses technology to partially or entirely replace the human driver in navigating a vehicle from an origin to a destination while avoiding road hazards and responding to traffic conditions. However, only vehicles that completely automatically travels without any intervention of a driver are not considered to be autonomous vehicles, and autonomous vehicle capabilities may be categorized in multiple levels depending on the degree of intervention of the driver. For example, an Advanced Driver-Assistance System (ADAS) may be considered as level 1 and level 2.

High-definition maps with centimeter (cm) level accuracy may be used for autonomous driving. However, the high-definition maps cost a lot of money from map construction to maintenance. In addition, since the high-definition maps have a large amount of data, Ethernet communication may have to be used to update, transmit and receive the high-definition maps, and high computing power and resource to process the data may be also required.

### SUMMARY

Therefore, some embodiments of the present disclosure may provide a driving assistance system capable of implementing autonomous driving even with low computing power or resource by using navigation information and camera information instead of high-definition maps for autonomous driving, a vehicle including the same, and a computer-readable recording medium.

In accordance with one aspect of the present disclosure, a driving assistance system includes a camera module provided in a vehicle and configured to capture a surrounding image and a controller configured to control driving of the vehicle based on camera information provided from the camera module and navigation information provided from a navigation module provided in the vehicle, and the controller is configured to compare a distance to a diverging point of a road on which the vehicle is traveling with a first reference distance, set a lane closest to the diverging point as a target lane when the distance to the diverging point is less than the first reference distance, and control the vehicle to move to the target lane.

The controller may set the first reference distance based on at least one of a traffic volume on the road on which the vehicle is traveling or a lane in which the vehicle is traveling.

The controller may set the first reference distance to be longer as the traffic volume on the road on which the vehicle is traveling increases.

The controller may set the first reference distance to be longer as the lane in which the vehicle is traveling is farther from the diverging point.

The controller may change a reference lane until the vehicle reaches the target lane; and move the vehicle to the reference lane so that the vehicle reaches the target lane.

The controller may move the vehicle to a diverged lane after the vehicle passes the diverging point.

The controller may compare a distance to a merging point with main road lanes with a third reference distance; set one of the main road lanes as the target lane when the distance to the merging point is less than the third reference distance; and control the vehicle to move to the target lane after the vehicle passes the merging point.

The controller may compare a distance to a next diverging point positioned on a driving route of the vehicle with a fourth reference distance; and set an n-th lane (n is an integer of 1 or more) among the main road lanes as the target lane when the distance to the next diverging point is less than the fourth reference distance, and set an m-th lane (m is an integer greater than or equal to 1 and smaller than n) among the main road lanes as the target lane when the distance to the next diverging point is greater than or equal to the fourth reference distance.

The controller may set an n-th lane (n is an integer of 2 or more) among the main road lanes as the target lane when there is an exclusive lane in the main road lanes; and set an m-th lane (m is an integer greater than or equal to 1 and smaller than n) among the main road lanes as the target lane when there is no exclusive lane in the main road lanes.

The controller may receive the camera information and the navigation information through controller area network (CAN) communication with the camera module and the navigation module.

In accordance with another aspect of the present disclosure, a computer-readable recording medium on which a driving assistance method is recorded is provided, and the driving assistance method includes receiving camera information from a camera module provided in a vehicle, receiving navigation information from a navigation module provided in the vehicle, comparing a distance to a diverging point of a road on which the vehicle is traveling with a first reference distance, setting a lane closest to the diverging point as a target lane when the distance to the diverging point is less than the first reference distance, and controlling the vehicle to move to the target lane.

The driving assistance method may further include setting the first reference distance based on at least one of a traffic volume on the road on which the vehicle is traveling or a lane in which the vehicle is traveling.

The setting of the first reference distance may include setting the first reference distance to be longer as the traffic volume on the road on which the vehicle is traveling increases.

The setting of the first reference distance may include setting the first reference distance to be longer as the lane in which the vehicle is traveling is farther from the diverging point.

The controlling of the vehicle to move to the target lane may include changing a reference lane until the vehicle reaches the target lane, and moving the vehicle to the reference lane so that the vehicle reaches the target lane.

The driving assistance method may further include moving the vehicle to a diverged lane after the vehicle passes the diverging point.

The driving assistance method may further include comparing a distance to a merging point with main road lanes with a third reference distance; setting one of the main road lanes as a target lane when the distance to the merging point is less than the third reference distance; and controlling the vehicle to move to the target lane after the vehicle passes the merging point.

The setting of one of the main road lanes as the target lane may include comparing a distance to a next diverging point positioned on a driving route of the vehicle with a fourth reference distance, and setting an n-th lane (n is an integer of 1 or more) among the main road lanes as the target lane when the distance to the next diverging point is less than the fourth reference distance, and setting an m-th lane (m is an integer greater than or equal to 1 and smaller than n) among the main road lanes as the target lane when the distance to the next diverging point is greater than or equal to the fourth reference distance.

The setting of one of the main road lanes as the target lane may include setting an n-th lane (n is an integer of 2 or more) among the main road lanes as the target lane when there is an exclusive lane in the main road lanes; and setting an m-th lane (m is an integer greater than or equal to 1 and smaller than n) among the main road lanes as the target lane when there is no exclusive lane in the main road lanes.

In accordance with still another aspect of the present disclosure, a vehicle includes a camera module configured to capture a surrounding image, a navigation module configured to acquire navigation information, and a controller configured to control driving of a vehicle based on camera information provided from the camera module and the navigation information provided from the navigation module, in which the controller is configured to compare a distance to a diverging point of a road on which the vehicle is traveling with a first reference distance, set a lane closest to the diverging point as a target lane when the distance to the diverging point is less than the first reference distance, and control the vehicle to move to the target lane.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a block diagram illustrating operations of a vehicle and a driving assistance system included in the vehicle in accordance with one embodiment of the present disclosure;

FIG. 2 is a table showing examples of navigation information provided from a navigation module of a vehicle and camera information provided from a camera module in accordance with one embodiment of the present disclosure;

FIGS. 3 and 4 are a schematic diagram and a table for illustrating an example of navigation information provided from a navigation module of a vehicle in accordance with one embodiment of the present disclosure;

FIG. 5 is an example of camera information provided by a camera module of a vehicle in accordance with one embodiment of the present disclosure;

FIG. 6 is a flowchart showing a driving assistance method in accordance with one embodiment of the present disclosure;

FIG. 7 is an example of an operation of changing lanes toward a highway diverging point by a driving assistance method in accordance with one embodiment of the present disclosure;

FIG. 8 is a flowchart for illustrating a driving assistance method in accordance with another embodiment of the present disclosure;

FIG. 9 is a flowchart for showing a lane change operation of a vehicle after passing a diverging point in a driving assistance method in accordance with one embodiment of the present disclosure;

FIG. 10 is an example for illustrating the lane change operation according to the driving assistance method illustrated in FIG. 9;

FIG. 11 is a flowchart showing an operation of merging a vehicle into a main road lane in a driving assistance method in accordance with one embodiment of the present disclosure;

FIG. 12 is an example for illustrating a lane change operation according to the driving assistance method shown in FIG. 11;

FIG. 13 is a flowchart for illustrating an operation of setting a main road lane as a target lane in a driving assistance method in accordance with one embodiment of the present disclosure;

FIG. 14 is an example for illustrating a lane change operation according to the driving assistance method shown in FIG. 13; and

FIG. 15 is a flowchart for illustrating an operation of setting a main road lane as a target lane in a driving assistance method in accordance with another embodiment of the present disclosure.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. The progression of processing operations described is an example; however, the sequence of and/or operations is not limited to that set forth herein and may be changed as is known in the art, with the exception of operations necessarily occurring in a particular order. In addition, respective descriptions of well-known functions and constructions may be omitted for increased clarity and conciseness.

Additionally, exemplary embodiments will now be described more fully hereinafter with reference to the accompanying drawings. The exemplary embodiments may, however, be embodied in many different forms and should not be construed as being limited to the embodiments set forth herein. These embodiments are provided so that this disclosure will be thorough and complete and will fully convey the exemplary embodiments to those of ordinary skill in the art. Like numerals denote like elements throughout.

It will be understood that, although the terms first, second, etc. may be used herein to describe various elements, these elements should not be limited by these terms. These terms are only used to distinguish one element from another. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present.

The terminology used herein is for the purpose of describing particular embodiments only and is not intended to be limiting. As used herein, the singular forms “a,” “an,” and “the,” are intended to include the plural forms as well, unless the context clearly indicates otherwise.

The expression, “at least one of a, b, and c,” should be understood as including only a, only b, only c, both a and b, both a and c, both b and c, or all of a, b, and c.

Reference will now be made in detail to the exemplary embodiments of the present disclosure, examples of which are illustrated in the accompanying drawings, wherein like reference numerals refer to like elements throughout.

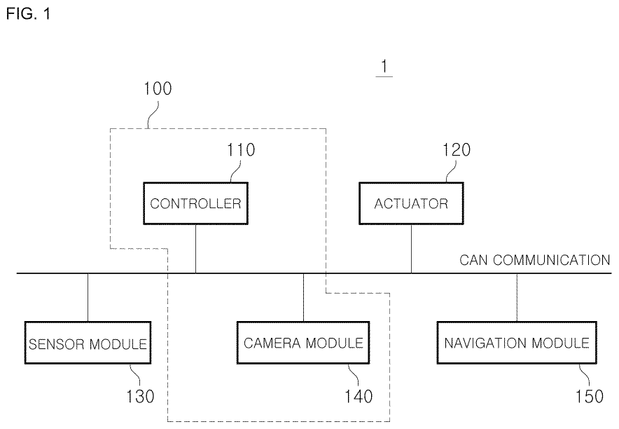

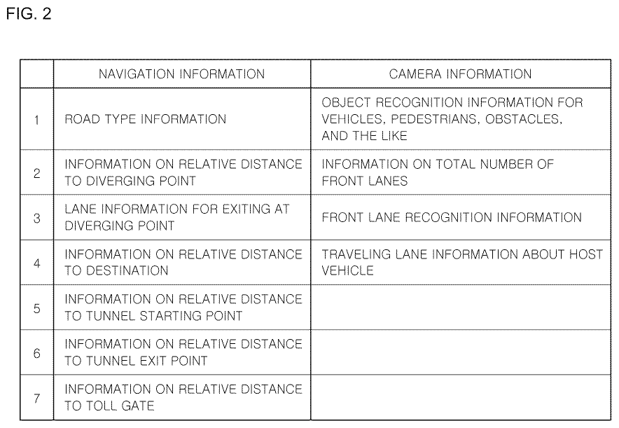

FIG. 1 is a block diagram illustrating operations of a vehicle and a driving assistance system included in the vehicle in accordance with one embodiment of the present disclosure, and FIG. 2 is a table showing examples of navigation information provided from a navigation module of a vehicle and camera information provided from a camera module in accordance with one embodiment of the present disclosure.

As illustrated in FIG. 1, a vehicle 1 may include a controller 110, an actuator 120, a sensor module 130, a camera module 140, and a navigation module or navigator 150.

The vehicle 1 in accordance with one embodiment of the present disclosure may perform autonomous driving. For example, according to levels commonly used in the industry, the vehicle 1 may implement autonomous driving of level 2, level 3, or level 4, but not limited thereto.

The autonomous driving of the vehicle 1 in accordance with one embodiment may be performed by a driving assistance system 100. Therefore, the driving assistance system 100 may perform driver assistance and autonomous driving according to an autonomous driving level and driving mode. For example, when the driving mode is set to a driving assistance mode, the driving assistance system 100 may assist a driver, and when the driving mode is set to an autonomous driving mode, the driving assistance system 100 may perform autonomous driving.

The driving assistance system 100 may include the controller 110. In addition, the driving assistance system 100 may further include the camera module 140. However, components included in the driving assistance system 100 may vary depending on the level of autonomous driving implemented by the driving assistance system 100, and therefore the driving assistance system 100 can include any component shown in FIG. 1 if necessary.

The components included in the driving assistance system 100 may vary depending on the design of the driving assistance system 100 and the vehicle 1. For example, the sensor module 130 and/or the navigation module 150 may be be included in the driving assistance system 100 if necessary.

The block diagram of FIG. 1 illustrates components related to an exemplary embodiment of the present disclosure for illustration purposes only. Therefore, various components not illustrated in FIG. 1 may be also added to the driving assistance system 100 or the vehicle 1.

The controller 110 may perform operations related to the autonomous driving of the vehicle 1. As one example, the controller 110 may control an operation of the vehicle 1 entering or exiting a highway through an appropriate lane change at an interchange (IC) or junction (JC).

The “highway” mentioned in the present embodiment may include all roads that are distinguished from general roads and allow entry and exit through access roads and exit roads.

In addition, the “diverging point” mentioned in the present embodiment may include any point where a lane diverges so that a vehicle is able to change from one highway on which the vehicle is traveling to another highway or to exit a highway and transfer to a general road.

The controller 110 may include at least one memory storing a program for performing operations described herein and/or data associated with the program and at least one processor executing the stored program. In addition, at least one memory included in the controller 110 is a computer-readable recording medium such as a non-transitory computer-readable medium and may non-temporarily store programs.

For instance, the controller 110 may be implemented by integrating a plurality of electronic control units (ECUs), and may be referred to as an automated driving control unit (ADCU).

The actuator 120 may perform acceleration, braking, and steering of the vehicle 1, and for these purposes, may include a driving module, a braking module, a steering module, and the like.

The drive module generates power required to move the vehicle 1. For example, the driving module may include one or more of an engine, an engine management system (EMS), a transmission, and a transmission control unit (TCU) or transmission controller.

The engine may generate power for driving the vehicle 1, and the engine management system may control the engine in response to a driver's willingness to accelerate through an accelerator pedal and/or a request or a control signal from the driving assistance system 100. The transmission may transmit the power generated by the engine to wheels, and the transmission control unit may control the transmission in response to a driver's shift command through a shift lever and/or a request or a control signal from the driving assistance system 100.

Alternatively, the driving module may include one or more of a drive motor, a reducer (e.g. a gear mechanism and/or a belt mechanism), a battery, a power control device, or the like. In this case, the vehicle 1 may be implemented as an electric vehicle.

Alternatively, the driving module may include both engine-related devices and drive motor-related devices. In this case, the vehicle 1 may be implemented as a hybrid vehicle.

The braking module may be configured to perform brake operations such as slowing down or stopping the vehicle 1 by using a brake. For example, the braking module may include a brake caliper and an electronic brake control module (EBCM). The brake caliper may decelerate the vehicle 1 or stop the vehicle 1 using friction with a brake disc.

The electronic brake control module may control the brake caliper in response to a driver's willingness to brake the vehicle 1 through a brake pedal or a request or a control signal from the driving assistance system 100. For example, the electronic brake control module may receive a brake request or control signal including deceleration rate information from the driving assistance system 100 and electrically or hydraulically control the brake caliper in order to slow down or stop the vehicle 1 based on the requested deceleration rate information.

The steering module may include an electronic power steering control module (EPS). The steering module may control or change a driving direction of the vehicle 1, and the electronic power steering control module may assist the operation of the steering module so that the driver may easily operate the steering wheel in response to a driver's willingness to steer through a steering wheel.

Further, the electronic power steering control module may control the steering module in response to a request or a control signal from the driving assistance system 100. For example, the electronic power steering control module may receive a steering request or a control signal including information related to steering torque from the driving assistance system 100 and control the steering module so that the vehicle 1 can be steered based on the requested steering torque.

The sensor module 130 may detect a driving environment of the vehicle 1 or behavior of the vehicle 1. For example, the sensor module 130 may include radio detection and ranging (radar). The radar may transmit transmission radio waves toward surroundings of the vehicle 1 and detect objects around the vehicle 1 based on reflected radio waves reflected from the surrounding objects.

The radar may include a transmission antenna (or a transmission antenna array) for radiating transmission signals, that is, transmission radio waves, toward the surroundings of the vehicle 1 and a reception antenna (or a reception antenna array) for receiving reflected signals, that is, reflected radio waves, reflected back from an object.

The radar may obtain radar data from the transmission radio waves emitted by the transmission antenna and reflected radio waves received by the reception antenna. The radar data may include, for instance, but not limited to, position information (e.g., distance information) or speed information about one or more objects around the vehicle 1.

The radar may include a processor for processing the radar data. Alternatively, the processor for processing the radar data may be included in the controller 110 and the radar is electrically or communicationally connected to the processor comprised in the controller 110.

The processor may acquire the radar data from the reception antenna of the radar and generate a track corresponding to an object by clustering reflection points of the reflected signals. For example, the processor may calculate or acquire a distance of the track based on a time difference between a transmission time of a transmission radio wave and a reception time of a reflected radio wave, and calculate or acquire a relative speed of the track based on a difference between a frequency of the transmission radio wave and a frequency of the reflected radio wave.

The processor may transmit data about the track (or the distance and relative speed of the track) around the vehicle 1 (hereinafter referred to as a “radar track”) acquired from the radar data to the controller 110. The controller 110 may assist the driver or perform autonomous driving based on the radar track.

Alternatively, the sensor module 130 may include light detection and ranging (LiDAR). The LiDAR may transmit light (e.g., infrared rays) toward surroundings of the vehicle 1 and detect one or more surrounding objects around the vehicle 1 based on reflected light reflected from the surrounding object. The LiDAR may include a light source (e.g., a light emitting diode, a light emitting diode array, a laser diode, or a laser diode array) emitting light (e.g., infrared rays), and an optical sensor (e.g., a photodiode or a photodiode array) receiving light (e.g., infrared rays). In addition, the LIDAR may further include a driving device for rotating or moving a light source or the optical sensor as needed.

The LiDAR may emit light through the light source and receive light reflected from the object through the light sensor while the light source or the light sensor rotates or moves, thereby acquiring LiDAR data.

The LiDAR data may include relative positions (e.g. distances to or directions of surrounding objects) or relative speeds of the surrounding objects of the vehicle 1.

The LiDAR may include a processor configured to process the LiDAR data. Alternatively, the processor for processing the LiDAR data may be included in the driving assistance system 100.

The processor may generate a track corresponding to the object by clustering reflection points by reflected light. The processor may acquire a distance to the object based on, for example, a time difference between a light transmission time and a light reception time. In addition, the processor may acquire a direction (or angle) of the object with respect to a driving direction of the vehicle 1 based on a direction in which the light source emits light when the optical sensor receives the reflected light.

The processor may transmit data about the track (for example, the distance and relative speed of the track) around the vehicle 1 (hereinafter referred to as a “LiDAR track”) acquired from the LiDAR data to the controller 110.

Both radar and LiDAR have been described as examples for illustration purposes, but the vehicle 1 in accordance with an embodiment of the present disclosure may include only one of the radar and the LiDAR, or may include both the radar and the LiDAR. That is, the present disclosure is not limited to a specific example of whether radar and LiDAR are included or not.

In addition, the sensor module 130 may also include at least one of behavior sensors such as a vehicle speed sensor for detecting speed of the vehicle 1, an acceleration sensor for detecting a longitudinal acceleration and a lateral acceleration of the vehicle 1, and/or a gyro sensor for detecting a yaw rate, a roll rate, or a pitch rate of the vehicle 1.

The camera module 140 may include at least one camera for capturing images around the vehicle 1. For example, the camera module 140 may include a front camera installed on a front windshield of the vehicle 1 or facing the front of the vehicle 1 and a side camera installed on the side of the vehicle 1 or facing the side of the vehicle 1. In addition, the camera module 140 may further include a rear camera installed at the rear of the vehicle 1 or facing the rear of the vehicle 1.

The camera module 140 may include a processor for processing a surrounding image captured by the camera to acquire necessary information. In the present embodiment, the information acquired by the camera module 140 and provided to the controller 110 will be referred to as camera information.

Referring to the exemplary embodiment of FIG. 2, the camera information acquired by the camera module 140 may include object recognition information for other vehicles, pedestrians, obstacles, and the like positioned or moving around the vehicle 1, information on the number of lanes on the road on which the vehicle 1 is traveling, front lane recognition information, traveling lane information about the vehicle 1, or the like.

The navigation module or navigator 150 may generate a route to a destination input by the driver and provide the generated route to the driver or the controller 110. The navigation module 150 may receive a global navigation satellite system (GNSS) signal from a GNSS and identify an absolute position (e.g. coordinates) of the vehicle 1 based on the GNSS signal. The navigation module 150 may generate a route to the destination based on the position (e.g. coordinates) of the destination input by the driver and the current position (e.g. coordinates) of the vehicle 1.

In the present embodiment, the information acquired by the navigation module 150 and provided to the controller 110 will be referred to as navigation information. Referring to the exemplary embodiment of FIG. 2, the navigation information may include, for example, but not limited to, road type information about a road on which the vehicle 1 is currently traveling or is going to travel later on a set route, information on a relative distance to a diverging point, lane information for exiting at the diverging point, information on a relative distance to a destination, information on a relative distance to a tunnel starting point when a tunnel is positioned on a driving route or the set route, information on a relative distance to a tunnel exit point, information on a relative distance to a toll gate when the toll gate is positioned on the driving route or the set route, and the like. The navigation module 150 may comprise a processor configured to process the navigation information. Optionally, the navigation module 150 may comprise a global positioning system (GPS) or be communicationally connected to the GPS, and/or the navigation module 150 may comprise a communicator configured to communicate with the GNSS, although not required.

Although not illustrated in the exemplary embodiment of FIG. 1, the vehicle 1 may include a display device such as a cluster display, head-up display, center fascia display, or the like. At least part of the navigation information may be displayed through the display device together with the route generated by the navigation module 150.

The above-mentioned components may exchange data with each other through a vehicle communication network. The controller 110 may use data provided from other components of the vehicle 1 as a basis for recognition or determination and transmit a control signal for controlling the vehicle 1 to other components of the vehicle 1 based on a recognition or determination result.

Various types of vehicle communication networks such as Ethernet, Media Oriented Systems Transport (MOST), FlexRay, Controller Area Network (CAN), Local Interconnect Network (LIN), or the like may be used for communication between the components of the vehicle 1.

When a high-definition map is used for autonomous driving, a lot of cost or resource is required from construction to maintenance of the high-definition map, and Ethernet communication for updating, transmitting and receiving map information and computing power or resource to process the map information also are needed.

The driving assistance system 100 in accordance with an embodiment of the present disclosure may implement autonomous driving using camera information and navigation information without using the high-definition map. Accordingly, the vehicle 1 in accordance with an embodiment of the present disclosure may exchange data between components using CAN communication. However, the present disclosure does not exclude using the high-definition map in the driving assistance system 100, although some exemplary embodiments of the present disclosure can be implemented without using the high-definition map.

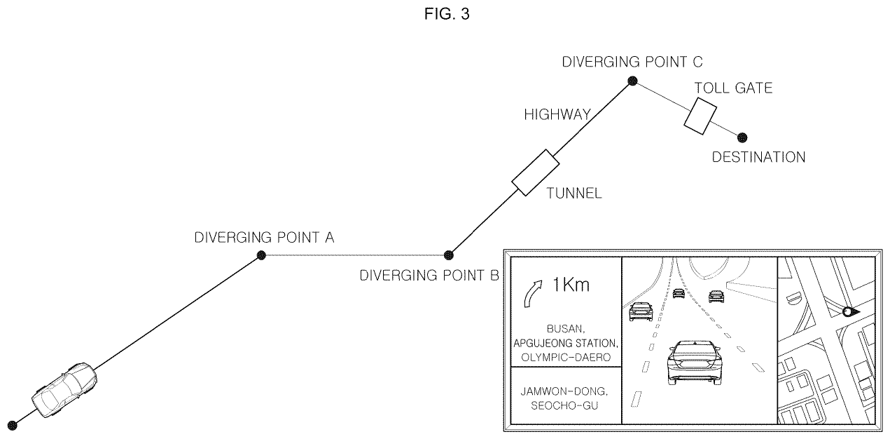

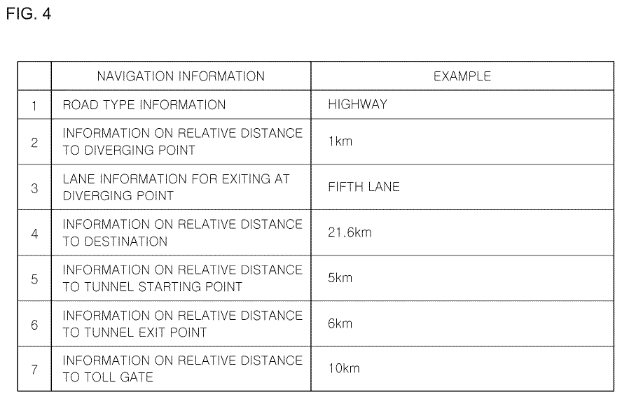

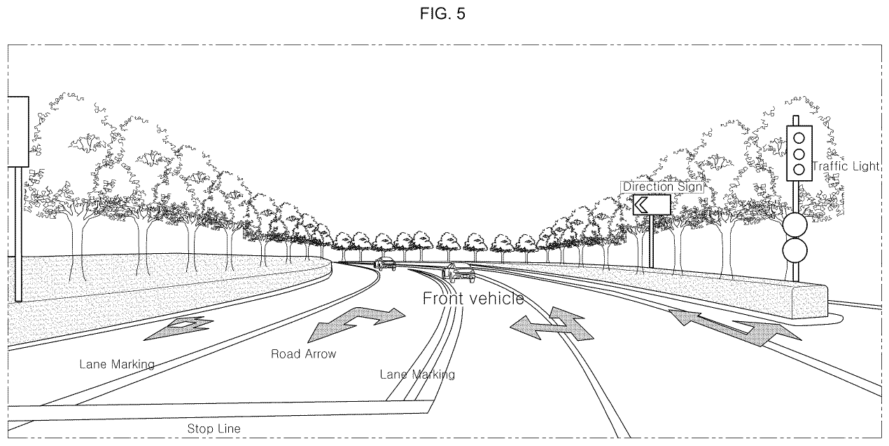

FIGS. 3 and 4 are a schematic diagram and a table for illustrating an example of navigation information provided by a navigation module of a vehicle in accordance with one embodiment of the present disclosure and FIG. 5 is an example of camera information provided by a camera module of a vehicle in accordance with one embodiment of the present disclosure.

In the example in FIG. 3, a route to a destination may include driving on a highway, and may include diverging points and a toll gate for entering and exiting the highway. In this case, as shown in FIG. 4, the navigation information may include road type information about a road on which the vehicle 1 is traveling based on a current position of the vehicle 1 (i.e. highway), information on a relative distance to a diverging point (i.e. a diverging point A closest to the current position), lane information for exiting at the diverging point (i.e. the fifth lane), information on a relative distance to the destination (i.e. 21.6 km), information on a relative distance to a tunnel starting point (i.e. 5 km), information on a relative distance to a tunnel exit point (i.e. 6 km), and information on a relative distance to a toll gate (i.e. 10 km).

When a front camera of the camera module 140 captures a surrounding image as in the example of FIG. 5, the processor of the camera module 140 or the processor connected with the camera module 140 may process the captured surrounding image and recognize various objects, lanes, and the like included in the surrounding image.

For example, the camera module 140 may recognize lanes and types of the recognized lanes included in the surrounding image. For instance, the camera module 140 may recognize the center lane or median strip, and based on the center lane or median strip, may determine how many lanes the road on which the vehicle 1 is traveling has.

In addition, the camera module 140 may recognize a lane as a solid line lane, a dotted line lane, a left turn lane, or a straight lane and generate lane information, and the recognized lane information may be used to determine whether or not the vehicle 1 is allowed to change lanes or whether the vehicle 1 has to change a lane.

Further, the camera module 140 may recognize and determine various objects included in the surrounding image. The camera module 140 may recognize other vehicles or pedestrians positioned in front of the vehicle 1, and may recognize traffic lights and a current state of the traffic lights and use the recognized state to determine whether or not the vehicle 1 travels or whether or not the vehicle 1 needs to slow down.

The controller 110 may fuse the above-described navigation information and camera information and use the fused information for autonomous driving and control of the vehicle 1. Hereinafter, some exemplary embodiments of the driving assistance system 100 or the driving assistance method using the vehicle 1 will be described.

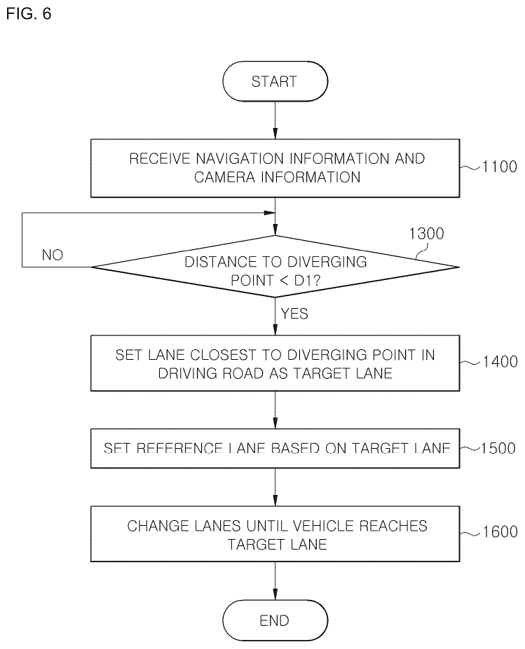

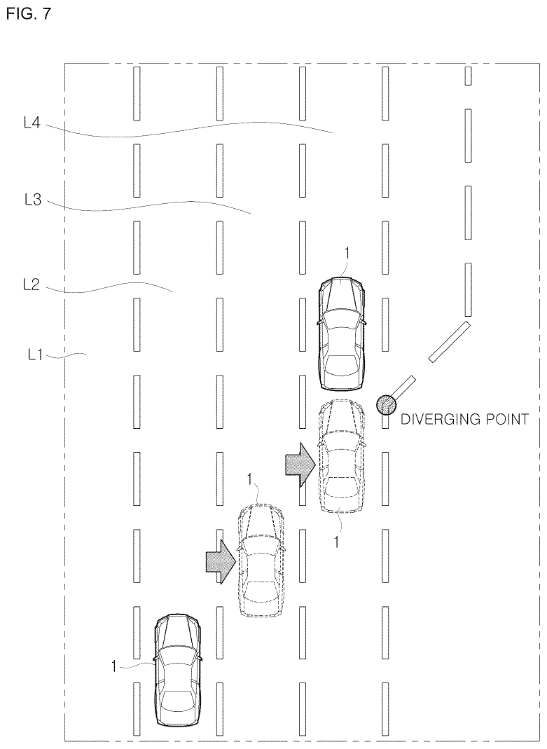

FIG. 6 is a flowchart showing a driving assistance method in accordance with an embodiment of the present disclosure, and FIG. 7 is an example of an operation of changing lanes toward a highway diverging point by a driving assistance method in accordance with an embodiment of the present disclosure.

Certain embodiments of a driving assistance method may be performed by the driving assistance system 100 described above or the vehicle 1 including the same. Description of the driving assistance method to be described below may be applied to or implemented in some embodiments of the driving assistance system 100 or the vehicle 1.

In accordance with the exemplary embodiment of the driving assistance method shown in FIG. 6, the controller 110 receives navigation information and camera information (step 1100).

The navigation information may be provided from the navigation module or navigator 150, and the camera information may be provided from the camera module 140. In addition, CAN communication may be used to communicate the navigation information.

The navigation information and the camera information may be provided in real time or periodically at certain time intervals (e.g. preset time intervals). In addition, depending on the driving mode of the vehicle 1, the navigation information and the camera information may be provided when a specific event or condition occurs or is satisfied.

The controller 110 may compare a distance from the current position of the vehicle 1 to a diverging point with a first reference distance D1 (step 1300). For instance, at step 1300, when the vehicle 1 is to exit a road on which the vehicle 1 is traveling, the controller 110 compares a distance from the current position of the vehicle 1 to the diverging point with the first reference distance D1

As described above, the navigation information includes information about a distance to a diverging point on a road on which the vehicle 1 is traveling. The diverging point is a point where multiple roads, routes, or lanes are diverged or where a new road, route, or lane starts, for example, but not limited to, a start point, a midpoint or an endpoint of an exit lane such as an off-ramp lane. When the vehicle 1 is required or navigated to exit through the corresponding diverging point on a set route, the controller 110 may compare the distance from the current position of the vehicle 1 to the diverging point with the first reference distance D1 and set a lane closest to the diverging point on a driving road as a target lane (step 1400) when the distance to the diverging point is less than the first reference distance D1 (Yes in step 1300).

For example, in FIG. 7, when the road where the vehicle 1 is traveling is a four-lane highway consisting of a first lane L1, a second lane L2, a third lane L3, and a fourth lane L4, the lane closest to the diverging point is the fourth lane L4. In this case, the controller 110 may set the fourth lane as the target lane.

The controller 110 may set a reference lane based on the target lane (step 1500) and control the vehicle 1 to change a lane or lanes until the vehicle 1 reaches to the target lane (step 1600).

In the present embodiment, the target lane is a lane to be finally reached by a lane change operation, and the reference lane is a next lane to which the vehicle 1 has to move from the current lane in order to reach the target lane. The controller 110 may set an adjacent lane on the right or left of the current driving lane (i.e. a lane that is a +1st or −1st from the current driving lane) as the reference lane until the vehicle 1 reaches to the target lane.

In the example shown in FIG. 7, the diverging point is positioned on the right side of the vehicle 1. Therefore, the third lane L3 that is an adjacent lane on the right or a +1st lane from the second lane L2 that is the current driving lane may be set as the reference lane. After the vehicle 1 moves to the third lane L3, the fourth lane L4 that is an adjacent lane on the right or a +1st lane from the third lane L3 may be set as the reference lane, and when the vehicle 1 reaches the fourth lane L4 that is the target lane, the lane change operation may be ended.

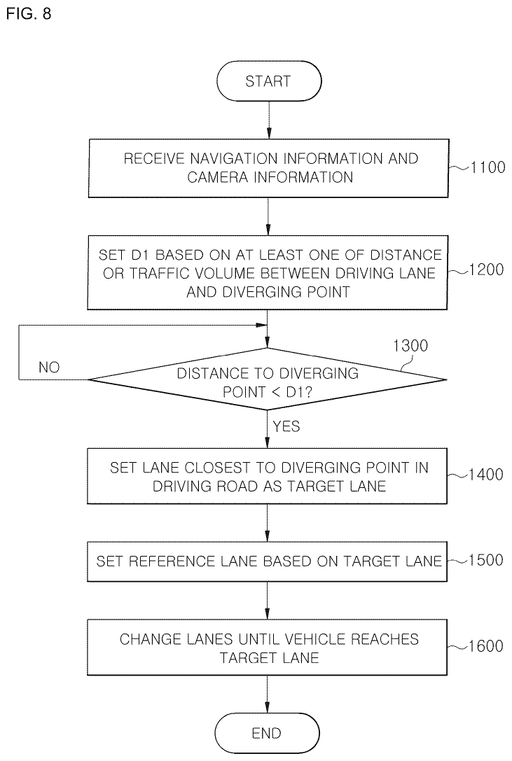

FIG. 8 is a flowchart for illustrating a driving assistance method in accordance with another embodiment of the present disclosure.

As described above, the controller 110 may determine whether to change a lane or lanes by comparing the distance to the diverging point with the first reference distance D1. In this case, a time required to change the lane(s) to the target lane may vary depending on a current situation. Therefore, in another embodiment of the present disclosure shown in FIG. 8, the first reference distance D1 may be set based on at least one of the distance or a traffic volume between the driving lane and the diverging point (step 1200).

Referring back to the example of FIG. 7, when the diverging point is positioned on the right side of the vehicle 1, the time required to move to the fourth lane L4 that is the target lane varies depending on whether the vehicle 1 is traveling in the first lane L1 or in the third lane L3. Since the vehicle 1 traveling in the first lane L1 takes a longer time to reach to the target lane than the vehicle 1 traveling in the third lane L3, the controller 110 may start changing lanes sooner and set the first reference distance D1 to be longer when the vehicle 1 is traveling in the first lane L1.

Further, the first reference distance D1 may be adjusted depending on the traffic of the road where the vehicle 1 is traveling or will travel. When there is a large traffic volume on the road, it takes longer to change a lane or lanes. Accordingly, the controller 110 may set the first reference distance D1 to be longer when there is a larger traffic volume. Information about the traffic volume may be included in the navigation information or information received from the camera module 140.

As one example, a first reference distance table having a plurality of predetermined first reference distances that vary depending on the driving lane in which the vehicle 1 is driving and the number of lanes of the road in which the vehicle 1 is driving or a first reference distance table having a plurality of first reference distances that vary depending on the traffic volume may be preset and stored, and the controller 110 may select the first reference distance matching the current driving lane or current traffic volume from the table.

Alternatively, an algorithm configured to calculate and output an appropriate first reference distance based on the driving lane or traffic volume may also be provided, and as one example, the algorithm may be a pre-trained deep learning algorithm.

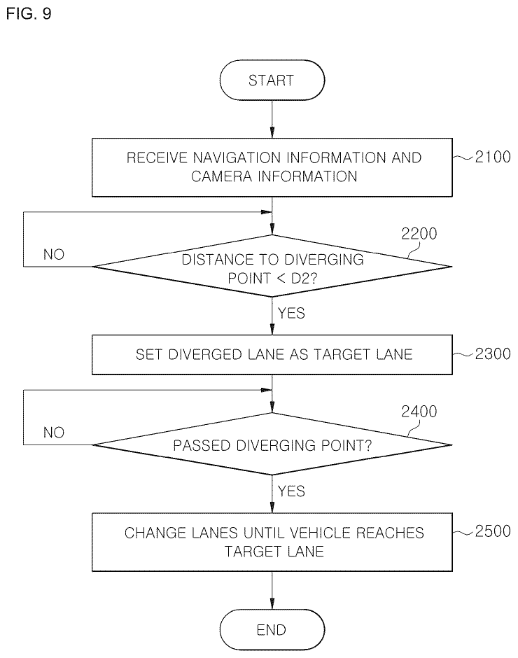

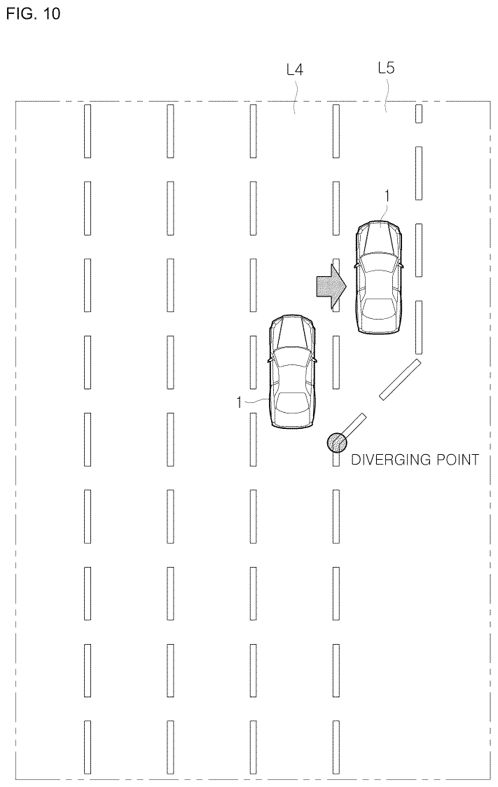

FIG. 9 is a flowchart for showing a lane change operation of a vehicle after passing a diverging point in a driving assistance method in accordance with an embodiment of the present disclosure, and FIG. 10 is an example for illustrating the lane change operation according to the driving assistance method illustrated in FIG. 9.

The controller 110 receives navigation information and camera information (step 2100).

The controller 110 may compare a distance to a diverging point with a second reference distance D2, and set a diverged lane (for example, an off-ramp lane) as a target lane (step 2300) when the distance to the diverging point is less than the second reference distance D2 (Yes in step 2200).

For example, the operation performed in the exemplary embodiment of FIG. 9 is an operation performed in a state where the vehicle 1 has moved to a lane closest to the diverging point to exit the highway, as previously described with reference to FIGS. 6 to 8. Therefore, as illustrated in FIG. 10, in the state where the vehicle 1 is traveling in the fourth lane L4 closest to the diverging point, the controller 110 may set a diverged lane L5 (e.g. an off-ramp lane) as the target lane when the distance to the diverging point is less than the second reference distance D2.

In general, after the vehicle 1 passes the diverging point, a new lane appears for exiting the highway, and in the present embodiment, the lane appearing after the diverging point is referred as the “diverged lane”. The diverged lane is included in the camera information.

When the vehicle 1 passes the diverging point (Yes in step 2400), the controller 110 may change a lane or lanes until the vehicle reaches to the target lane (2500).

The operation of setting the reference lane and moving the vehicle 1 to the reference lane to reach the target lane according to the present embodiment is the same as or similar to the exemplary embodiments and examples described above.

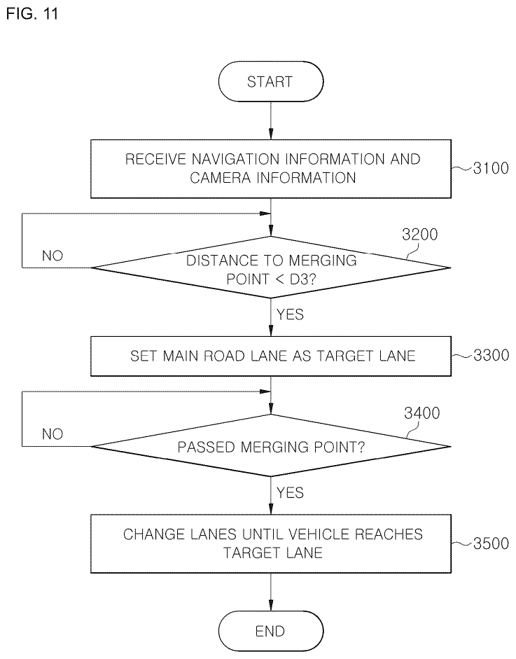

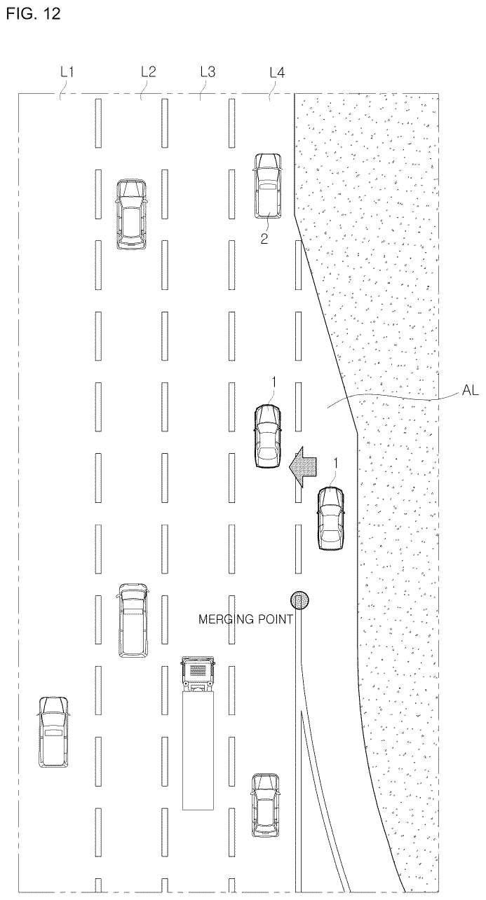

FIG. 11 is a flowchart showing an operation of merging a vehicle into a main road lane in a driving assistance method in accordance with an embodiment of the present disclosure, and FIG. 12 is an example for illustrating a lane change operation according to the driving assistance method shown in FIG. 11.

Referring to FIG. 11, the controller 110 receives navigation information and camera information (step 3100).

The controller 110 may compare the distance from a current position of the vehicle 1 to a merging point with a third reference distance D3 (step 3200). The merging point is a point where multiple roads, routes, or lanes are merged or a start point, a midpoint or an endpoint of an exit lane such as an on-ramp lane. For instance, at step 3200, when the vehicle 1 is to enter main road lanes from another road, the controller 110 compares the distance from the current position of the vehicle 1 to the merging point with the third reference distance D3. Here, the another road may be another highway, freeway, local road, general road, or any road merged with a road which the vehicle is to enter.

The operation described in the example shown in FIG. 12 is an operation for the vehicle 1 to merge onto a new highway after exiting at the diverging point of another highway to change highways. Alternatively, even if the operation is not an operation for changing highways, the same or similar operation described in the exemplary embodiments of FIGS. 11 and 12 may be applied or performed when the vehicle 1 enters a highway from a general road.

Referring to FIG. 12, when the vehicle enters a highway from another highway or a general road, the vehicle travels in an acceleration lane or on-ramp lane AL before merging into a main road lane. Since there may be a risk of an accident when the newly merging vehicle enters a main road lane at a very low speed, it is preferable to accelerate to an appropriate speed in the acceleration lane or on-ramp lane AL before merging into the main road lane and then merge into the main road lane.

The controller 110 may accelerate the vehicle 1 based on information such as the length of the acceleration lane or on-ramp lane AL, the speed of another vehicle traveling in a lane closest to the acceleration lane AL among main road lanes, and the traffic volume in the main road lanes.

The controller 110 may set the main road lane as a target lane (step 3300) when the distance to the merging point is less than the third reference distance D3 (Yes in step 3200), and may change a lane or lanes until the vehicle reaches to the target lane (step 3500) when the vehicle has passed the merging point (Yes in step 3400).

The controller 110 may set one of main road lanes consisting of a first lane L1 to a fourth lane L4 as the target lane. The operation of setting the reference lane and moving the vehicle 1 to the reference lane to reach to the target lane is the same as or similar to the exemplary embodiments described above. For example, when the main road lanes are positioned on the left side of the acceleration lane or on-ramp lane AL, a lane that is an adjacent lane on the left or a −1st lane from the current driving lane may be set as the reference lane.

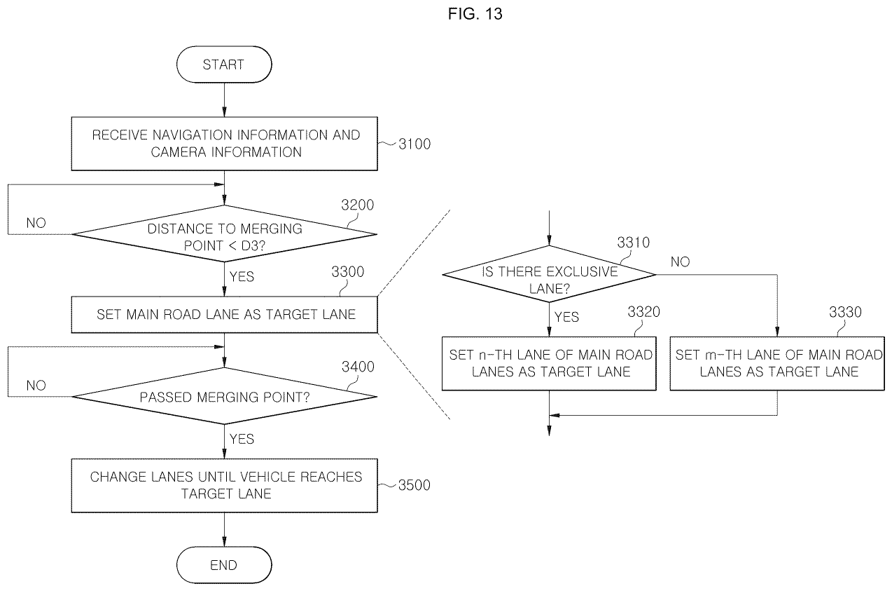

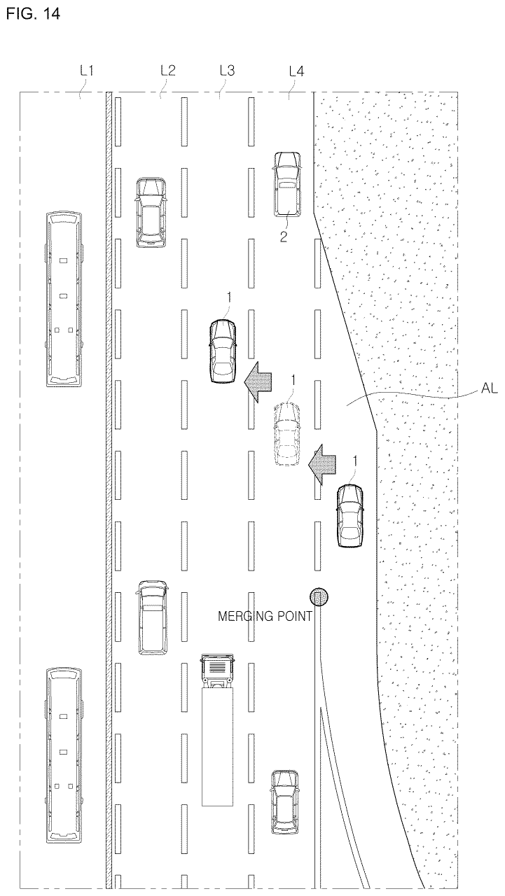

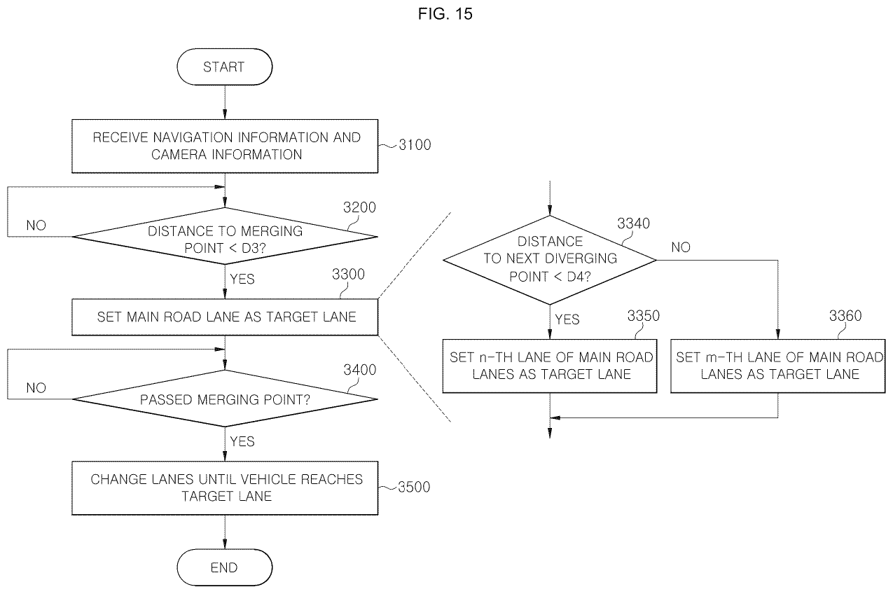

FIG. 13 is a flowchart for illustrating an operation of setting a main road lane as a target lane in a driving assistance method in accordance with an embodiment of the present disclosure, and FIG. 14 is an example for illustrating a lane change operation according to the driving assistance method shown in FIG. 13. FIG. 15 is a flowchart for illustrating an operation of setting a main road lane as a target lane in a driving assistance method in accordance with another embodiment of the present disclosure.

Referring to FIG. 13, in order to set one of main road lanes as a target lane, the controller 110 may determine whether an exclusive lane exists in the main road lanes (step 3310). For example, some highways may have one or more exclusive lanes for allowing only vehicles, which meet a requirement such as a law or regulation, to drive thereon, for example, but not limited to, buses, vehicles with a certain number of people or more on board, vehicles that have paid to travel.

Information about these exclusive lanes may be included in navigation information, and the controller 110 may set an n-th lane of the main road as the target lane (step 3320) when there is such an exclusive lane on the main road (Yes in step 3310), and set an m-th lane of the main road as the target lane (step 3330) when there is no exclusive lane (No in step 3310).

N and m are integers of 1 or more, and as one example, n may be 3 and m may be n−1. For example, referring to the example of FIG. 14, when a first lane L1 is the exclusive lane, a second lane L2 is set as an overtaking lane, and the controller 110 may set a third lane (n=3) that is the next lane to the overtaking lane as the target lane. However, when there is no exclusive lane on the road where the vehicle 1 is driving, the first lane L1 is set as the overtaking lane, and the controller 110 may set the second lane (m=2) that is the next lane to the overtaking lane as the target lane.

However, of course, it is possible to set n=2 and m=1 depending on a driver's driving tendency. In this case, the controller 110 may set the target lane as an overtaking lane based on an average driving speed of the vehicle 1 and a frequency of overtaking other vehicles in a self-driving mode in which the driver directly drives the vehicle.

Alternatively, it is also possible to provide the driver with an option to select which lane to drive in when entering a highway.

Meanwhile, the above-mentioned examples assume a case where the vehicle 1 is not a vehicle that is allowed to travel in the exclusive lane. However, when the vehicle 1 is a vehicle that is allowed to travel in the exclusive lane, the exclusive lane may be set as the target lane.

In addition, a remaining part of the route of vehicle 1 may also be considered in setting the target lane.

Referring to the example of FIG. 15, the controller 110 may compare a distance to a next diverging point with a fourth reference distance D4 to set one of main road lanes as a target lane (step 3340).

Here, the next diverging point means a next diverging point where the vehicle 1 will exit on a driving route set to a destination, and information about the distance to the next diverging point is included in navigation information.

When a distance from the current position of the vehicle 1 to the next diverging point is shorter than the fourth reference distance D4 (Yes in step 3340), there is no need to move to a lane further away from the current diverging point. Accordingly, an n-th lane of the main road may be set as the target lane (step 3350), and for example, when the main road lanes consist of a total of p lanes, n may satisfy p−1≤n≤p (p is an integer of 2 or more).

However, the above example assumes a case where the diverging point is positioned on the right side of the road, and when the diverging point is positioned on the left side of the road, n may satisfy 1≤n≤2.

When a distance from the current position of the vehicle 1 to the next diverging point is greater than the fourth reference distance D4 (No in step 3340), the vehicle 1 may move further to the left compared with a case where a distance to the next diverging point is shorter than the fourth reference distance D4, and for this purpose, an m-th lane of the main road may be set as the target lane (step 3360). As one example, m may satisfy 1≤m<n−1.

In accordance with some embodiments of the present disclosure, autonomous driving of a vehicle may be performed using navigation information and camera information without using high-definition maps that take a lot of time and money to construct and maintain.

In particular, since the vehicle may reach a target lane by changing lanes using only navigation information and camera information when the vehicle enters and exits a highway, efficient autonomous driving may be implemented without employing a high-specification processor or communication module.

Meanwhile, the disclosed embodiments may be implemented in the form of a recording medium storing instructions executable by a computer. For example, instructions for performing the above-described driving assistance method may be stored in the form of program codes, and when executed by a processor, may perform operations of the disclosed embodiments. The recording medium may be implemented as a computer-readable recording medium.

The computer-readable recording medium includes all types of recording media in which instructions capable of being decoded by a computer are stored. For example, there may be a read only memory (ROM), a random access memory (RAM), a magnetic tape, a magnetic disk, a flash memory, an optical data storage device, and the like.

A machine-readable storage medium may be provided in the form of a non-transitory storage medium. For example, the “non-transitory storage medium” may include a buffer in which data is temporarily stored.

According to one aspect of the present disclosure, autonomous driving can be implemented even with low computing power by using navigation information and camera information instead of high-definition maps for autonomous driving.

Exemplary embodiments of the present disclosure have been described above. In the exemplary embodiments described above, some components may be implemented as a “module”. Here, the term “module” means, for example, but not limited to, a software and/or hardware component, such as a Field Programmable Gate Array (FPGA) or Application Specific Integrated Circuit (ASIC), which performs certain tasks. The module may advantageously be configured to reside on the addressable storage medium and configured to execute on one or more processors.

Thus, the module may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The operations provided for in the components and modules may be combined into fewer components and modules or further separated into additional components and modules. In addition, the components and modules may be implemented such that they execute one or more CPUs in a device.

With that being said, and in addition to the above described exemplary embodiments, embodiments can thus be implemented through computer readable code/instructions in/on a medium, e.g., a computer readable medium, to control at least one processing element to implement any above described exemplary embodiment. The medium can correspond to any medium/media permitting the storing and/or transmission of the computer readable code.

The computer-readable code can be recorded on a medium or transmitted through the Internet. The medium may include Read Only Memory (ROM), Random Access Memory (RAM), Compact Disk-Read Only Memories (CD-ROMs), magnetic tapes, floppy disks, and optical recording medium. Also, the medium may be a non-transitory computer-readable medium. The media may also be a distributed network, so that the computer readable code is stored or transferred and executed in a distributed fashion. Still further, as only an example, the processing element could include at least one processor or at least one computer processor, and processing elements may be distributed and/or included in a single device.

While exemplary embodiments have been described with respect to a limited number of embodiments, those skilled in the art, having the benefit of this disclosure, will appreciate that other embodiments can be devised which do not depart from the scope as disclosed herein. Accordingly, the scope should be limited only by the attached claims.

What is claimed is:

1. A driving assistance system comprising:
a camera module associated with a vehicle and configured to capture a surrounding image to generate camera information representing an environment of the vehicle; and
a controller configured to control driving of the vehicle based on the camera information provided from the camera module and navigation information provided from a navigator associated with the vehicle,
wherein the controller is configured to:
when the vehicle is to exit a road on which the vehicle is traveling, compare a distance to a diverging point of the road on which the vehicle is traveling with a first reference distance; and
when the distance to the diverging point of the road on which the vehicle is traveling is shorter than the first reference distance, control the vehicle to perform lane change to a target lane to move the vehicle to a lane closest to the diverging point among lanes of the road.

2. The driving assistance system according to claim 1, wherein the controller is configured to set the first reference distance based on at least one of a traffic volume on the road on which the vehicle is traveling or a lane in which the vehicle is traveling.

3. The driving assistance system according to claim 1, wherein the controller is configured to set the first reference distance to be longer as a traffic volume on the road on which the vehicle is traveling is higher.

4. The driving assistance system according to claim 1, wherein the controller is configured to set the first reference distance to be longer as a lane in which the vehicle is traveling is farther from the diverging point of the road.

5. The driving assistance system according to claim 1, wherein the controller is configured to:
change a reference lane, which is a lane closer to the target lane among lanes next to a lane on which the vehicle is traveling, until the vehicle reaches the target lane; and
move the vehicle to the reference lane so that the vehicle reaches the target lane.

6. The driving assistance system according to claim 1, wherein the controller is configured to move the vehicle to a diverged lane after the vehicle passes the diverging point of the road.

7. The driving assistance system according to claim 1, wherein the controller is configured to:
when the vehicle is to enter main road lanes from another road, compare a distance to a merging point of the main road lanes and the another road with a third reference distance;
set one of the main road lanes as the target lane when the distance to the merging point of the main road lanes and the another road is less than the third reference distance; and
control the vehicle to move to the target lane after the vehicle passes the merging point of the main road lanes and the another road.

8. The driving assistance system according to claim 7, wherein the controller is configured to:
compare a distance to a next diverging point positioned on a coming driving route of the vehicle with a fourth reference distance; and
when the distance to the next diverging point is less than the fourth reference distance, set an n-th lane (n is an integer of 1 or more) among the main road lanes as the target lane and, when the distance to the next diverging point is greater than or equal to the fourth reference distance, set an m-th lane (m is an integer greater than or equal to 1 and smaller than n) among the main road lanes as the target lane.

9. The driving assistance system according to claim 7, wherein the controller is configured to:
when at least one of the main road lanes is an exclusive lane, set an n-th lane (n is an integer of 2 or more) among the main road lanes as the target lane; and
when the main road lanes have no exclusive lane, set an m-th lane (m is an integer greater than or equal to 1 and smaller than n) among the main road lanes as the target lane.

10. The driving assistance system according to claim 1, wherein the controller is configured to receive the camera information and the navigation information through controller area network (CAN) communication with the camera module and the navigation module, respectively.

11. A non-transitory computer-readable medium configured to store instructions, that when executed by a processor, cause the processor to perform operations comprising:
receiving camera information from a camera module associated with a vehicle;
receiving navigation information from a navigator associated with the vehicle;
when the vehicle is to exit a road on which the vehicle is traveling, comparing a distance to a diverging point of the road on which the vehicle is traveling with a first reference distance;
when the distance to the diverging point of the road on which the vehicle is traveling is shorter than the first reference distance, controlling the vehicle to perform lane change to a target lane to move the vehicle to a lane closest to the diverging point among lanes of the road.

12. The non-transitory computer-readable medium according to claim 11, wherein the operations further comprise setting the first reference distance based on at least one of a traffic volume on the road on which the vehicle is traveling or a lane in which the vehicle is traveling.

13. The non-transitory computer-readable medium according to claim 11, wherein the operations further comprise setting the first reference distance to be longer as a traffic volume on the road on which the vehicle is traveling is higher.

14. The non-transitory computer-readable medium according to claim 11, wherein the operations further comprise setting the first reference distance to be longer as a lane in which the vehicle is traveling is farther from the diverging point of the road.

15. The non-transitory computer-readable medium according to claim 11, wherein the controlling of the vehicle to perform the lane change to the target lane comprises:
changing a reference lane, which is a lane closer to the target lane among lanes next to a lane on which the vehicle is traveling, until the vehicle reaches the target lane, and
moving the vehicle to the reference lane so that the vehicle reaches the target lane.

16. The non-transitory computer-readable medium according to claim 11, wherein the operations further comprise moving the vehicle to a diverged lane after the vehicle passes the diverging point of the road.

17. The non-transitory computer-readable medium according to claim 11, wherein the operations further comprise:
when the vehicle is to enter main road lanes from another road, comparing a distance to a merging point with main road lanes and the another road with a third reference distance;
when the distance to the merging point of the main road lanes and the another road is less than the third reference distance, setting one of the main road lanes as the target lane; and
controlling the vehicle to move to the target lane after the vehicle passes the merging point of the main road lanes and the another road.

18. The non-transitory computer-readable medium according to claim 17, wherein the setting of one of the main road lanes as the target lane comprises:
comparing a distance to a next diverging point positioned on a coming driving route of the vehicle with a fourth reference distance, and
when the distance to the next diverging point is less than the fourth reference distance, setting an n-th lane (n is an integer of 1 or more) among the main road lanes as the target lane and, when the distance to the next diverging point is greater than or equal to the fourth reference distance, setting an m-th lane (m is an integer greater than or equal to 1 and smaller than n) among the main road lanes as the target lane.

19. The non-transitory computer-readable medium according to claim 17, wherein the setting of one of the main road lanes as the target lane comprises:
when at least one of the main road lanes is an exclusive lane, setting an n-th lane (n is an integer of 2 or more) among the main road lanes as the target lane; and
when the main road lanes have no exclusive lane, setting an m-th lane (m is an integer greater than or equal to 1 and smaller than n) among the main road lanes as the target lane.

20. A vehicle comprising:
a camera module configured to capture a surrounding image to generate camera information representing an environment of the vehicle;
a navigator configured to acquire navigation information; and
a controller configured to control driving of a vehicle based on the camera information provided from the camera module and the navigation information provided from the navigator,
wherein the controller is configured to:
when the vehicle is to exit a road on which the vehicle is traveling, compare a distance to a diverging point of the road on which the vehicle is traveling with a reference distance; and
when the distance to the diverging point of the road on which the vehicle is traveling with the reference distance, control the vehicle to perform lane change to a target lane to move the vehicle to a lane closest to the diverging point among lanes of the road.
